(19) United States
(12) Patent Application Publication
(10) Pub. No.: US 2007/0135542 A1
(43) Pub. Date: Jun. 14, 2007

(54) Emulsifiers for use in water-based tackifier dispersions

(76) Inventors: Lykele Jan Boonstra, Hoofdplaat (NL); Clazina Cornelia Adriana Adriaanse, Heinkenszand (NL); Michaela Hofbauer, Roosendaal (NL); Joost Hubert Maas, Rotterdam (NL)

Correspondence Address: Tammye L. Taylor;Eastman Chemical Company, P.O. Box 511, Kingsport, TN, 37662-5075, US

(21) Appl. No.: 11/604,497

(22) Filed: Nov. 27, 2006

Related U.S. Application Data
(60) Provisional application No. 60/748,669, filed on Dec. 8, 2005.

(51) Int. Cl. C08J 3/02; C09D 11/02

(52) U.S. Cl. 524/270; 106/238

(57) ABSTRACT

Anionic emulsifiers based on rosin acid or derivatives thereof, and to methods of preparing said emulsifiers. The emulsifiers are useful for preparing tackifier dispersions having improved properties with respect to foam stability. As such, said tackifier dispersions are advantageously used in water-based adhesives providing improved adhesive and cohesive properties. The adhesives may be used for labels on any kind of surface, packaging applications, flooring adhesives, road markings or for any type of water-based tapes, barrier coatings or sealants.

This application claims benefit of provisional application entitled, EMULSIFIERS FOR USE IN WATER-BASED TACKIFIER DISPERSIONS, Ser. No. 60/748,669, filed Dec. 8, 2005, incorporated by reference herein.

### FIELD OF THE INVENTION

The present invention generally pertains to the field of emulsifiers and to the preparation of stable dispersions therewith.

### BACKGROUND OF THE INVENTION

Emulsifiers (a term understood to be synonymous with the term “surfactant” for the purposes of the present invention) provide stability and prevent coalescence of particles formed during emulsification. Emulsifiers furthermore prevent the coagulation or aggregation of particles in the final dispersion. Due to their amphiphilic character, emulsifier molecules have an affinity for both oil and water phases. As a result, a balance exists between emulsifier molecules present at the oil-water interface and molecules present in the oil and water phases. In the context of the present invention, the functionality of the inventive emulsifiers is primarily discussed in the context of tackifier dispersions. However, it is understood that the inventive emulsifier may readily be used to decrease the viscosity and/or improve emulsification of any other conceivable dispersions.

### DESCRIPTION OF RELATED PRIOR ART

U.S. Pat. No. 2,194,429 relates to a process for the production of condensation products on the basis of resin alcohols and resin amines suitable as assistants in the lacquer and other industries. The product obtained according to U.S. Pat. No. '429 comprises an abietinyl moiety connected to a (poly) oxyalkyl or oxyalkyl ether moiety. The link between abietinyl moiety and the chain is limited to an ether linkage. The length of the ether chain is seen as increasing water suitability and thus the general usefulness of the compounds for forming dispersions. U.S. Pat. No. '429 describes the functionalization of the free terminal hydroxyl group with sulphonating agents. U.S. Pat. No. '429 is primarily concerned with providing softening agents in lacquers.

U.S. Pat. No. 5,137,572 describes an emulsifier molecule consisting of a tall oil rosin acid moiety, a phosphate functionality and a hydrocarbon oxide portion. The total quantity of oxide units in the emulsifier according to U.S. Pat. No. '572 ranges between 50-100. The large number of oxide units is due to the use of the emulsifier to create mixing grade asphaltic emulsions. The disclosure of U.S. Pat. No. '572 is limited to preparing said asphaltic emulsions.

U.S. Pat. No. 6,274,657 relates to a surfactant for forming stable dispersions of rosin esters compatible with elastomeric latexes. The surfactant has the formula R¹-R²-R³. R¹ and R³ are each rosin (i. e. rosin, a rosin dimer or a mixture of rosin and rosin dimer). R² is selected from the group consisting of polyethylene glycol and modified PEG chains. The surfactant is prepared by esterifying the rosin material with polyethylene glycol. These compounds are used to stabilize rosin esters in tackifier dispersions.

All surfactants as described in U.S. Pat. No. '657 are non-ionic and water-solubility is achieved by introducing particularly long PEG chains (i. e., by having a large number of ethylene oxide units). A similar invention is described in U.S. Pat. No. 5,552,519, which also relates to a non-ionic surfactant based on a rosin acid moiety wherein the hydrophilic functionality is provided by high molecular weight polyethylene glycol chains.

A major concern in the production of water-based tackifier dispersions is the formation and the stability of foam. “Foam” can be regarded as air bubbles stabilized by emulsifier molecules that are present in the water phase. Stable foam can lead to the formation of coarse particles in the dispersion. The course particles are often the result of desiccation and may lead to filter blockage. Coarse particles also may induce dewetting of a film of the final product comprising the dispersion as applied on a substrate, thus causing holes in the final coating on the substrate. Foam formation induced by recycle flows in coating processes is also undesirable because air bubbles may cause holes in the final coating. Recycling of a coating applied to a substrate is common in the labeling/packaging industries and inevitably brings the product in contact with air—even if the adhesives and/or the tackifier dispersions were formulated in the absence of air.

Foam formation needs to be avoided, limited or broken down to minimize these and other potential drawbacks. Among other factors, breakdown of foam is influenced by the stability of air/liquid interfaces and the rate at which air bubbles move to the surface of the dispersion due to prevailing density differences. The latter can be controlled by adjusting the overall viscosity of the dispersion. In general, the foaming behavior improves, i. e. less foam is produced, as the viscosity of the dispersion is reduced.

Water-based tackifier dispersions as known from the prior art typically comprise alkyl phenol or alkyl alcohol ethoxylated anionic emulsifiers. Dispersions prepared with these emulsifiers are limited with respect to their foaming behavior and/or their total solids content and/or their particle size. In general, at least one of the following problems occurs using these emulsifiers: either foaming is observed or the solid content is not high enough or the particles are too large. The use of these emulsifiers known from the prior art typically leads to increased foam formation upon increasing the solid content of the dispersion.

The characteristics of emulsifiers can also have a significant effect on the cohesive and adhesive properties of adhesives. This is particularly true for water-based adhesives. Anionic emulsifiers known from the prior art, in particular alkyl phenol or alkyl alcohol ethoxylated anionic emulsifiers, are known to act as plasticizers and therefore decrease the cohesive strength of adhesives. Other surfactants known from the prior art tend to be non-ionic and are therefore not well suited for water-based dispersions with improved foaming characteristics.

Further, emulsifiers containing alkyl phenol ethoxylates are gradually being phased out of adhesives and other applications, due to the toxicity and oestrogenic activity of these compounds. Thus, there remains a need in the art to provide emulsifiers that are free of alkyl phenol ethoxylates.

There also remains a need in the art to provide emulsifiers that can be used for preparing tackifier dispersions that are not as limited with respect to total solids content and/or particle size as dispersions using emulsifiers known from the prior art in particular prior art dispersions comprising commonly used alkyl phenol or alkyl alcohol ethoxylated anionic emulsifiers. Ideally, increased solid content and/or decreased particle size should be achieved while still obtaining a reasonable foaming behavior.

Lastly, there remains a need in the art to provide tackifier dispersions to be used in adhesives, that avoid the disadvantages of the prior art while providing improved cohesive strength of the adhesives and/or to improved adhesion on a substrate.

### BRIEF SUMMARY OF THE INVENTION

The present invention relates to novel emulsifiers and to the preparation thereof. The invention further relates to the application of said emulsifiers to prepare novel water-based tackifier dispersions.

One aspect of the present invention pertains to emulsifiers for use in tackifier dispersions. The emulsifiers include at least one rosin acid moiety or at least one rosin acid derivative moiety, a polar chain attached to said rosin acid or rosin acid derivative, and an anionic head group attached to the polar chain, wherein the polar chain comprises at least two repeating units comprising at least one carbon-oxygen bond in at least one repeating unit.

Another aspect of the present invention pertains to water-based tackifier dispersions. Said water-based tackifier dispersions according to the present invention comprises at least one emulsifier according to the invention in combination with water and at least one of the following tackifiers: (i) at least one rosin ester, (ii) at least one hydrocarbon resin, for example, a C₅-C₉ hydrocarbon resin, (iii) at least one low molecular weight acrylate, or (iv) at least one terpene resin. Suitably, any mixture of two or more of these tackifiers, or of one of these tackifiers with another tackifier may be used.

A further aspect of the present invention pertains to the use of these water-based tackifier dispersions, in combination with elastomeric latexes. For example, the water-based tackifier dispersions according to the present invention may be used in combination with acrylic polymers or styrene butadiene rubber (SBR), to prepare water-based adhesives. The adhesives according to the present invention may be employed in the following fields: labels on any kind of surface, packaging applications, flooring adhesives, road markings or any type of water-based tapes, barrier coatings or sealants.

### BRIEF DESCRIPTION OF THE DRAWINGS

FIG. 1 illustrates the equilibrium of the emulsifier molecules present in the tackifier dispersions.

### DETAILED DESCRIPTION OF THE INVENTION

The present invention may be understood more readily by reference to the following detailed description of the invention and to the Examples included therein.

Before the present compositions of matter and methods are disclosed and described, it is to be understood that this invention is not limited to specific synthetic methods or to particular formulations, unless otherwise indicated, and, as such, may vary from the disclosure. It is also to be understood that the terminology used is for the purpose of describing particular embodiments only, and is not intended to limit the scope of the invention.

The singular forms “a”, “an”, and the “the” include plural referents, unless the context clearly dictates otherwise.

Optional or optionally means that the subsequently described event or circumstances may or may not occur. The description includes instances where the event or circumstance occurs, and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains.

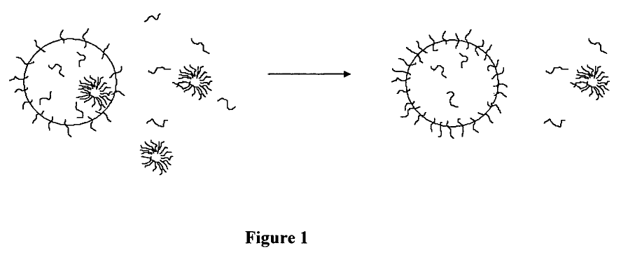

The present invention provides an emulsifier that improves the foaming behavior of dispersions, in particular tackifier dispersions. Without being bound to any theory, one reason why this improved foaming behavior may be achieved can be attributed to a reduction in dispersion viscosity. This reduction in the viscosity of the water phase is schematically illustrated in FIG. 1. The left panel of FIG. 1 represents a tackifier particle. As illustrated, an equilibrium exists between emulsifier molecules (prevailing as individual molecules or as micelles) present in the tackifier oil-phase, emulsifier molecules present at the tackifier oil-water interface and emulsifier molecules present in the water-phase.

The emulsifiers of the present invention may also be functionalized to have an increased affinity for the oil-water interface. This results in a decrease of emulsifier molecules present in the water-phase. As a consequence, a different equilibrium as shown in the right panel of FIG. 1 arises. Since fewer emulsifier molecules are present in the water-phase, the viscosity of the water-phase is reduced thus leading to a reduced viscosity of the dispersion overall. Furthermore, since fewer emulsifier molecules are present in the water-phase fewer molecules are available for stabilizing air-water interfaces. Stabilized air-water interfaces can be seen as one reason for increased foam production and foam stability. Thus, without being bound by any theory the emulsifiers of the present invention may improve the foaming behavior of dispersions prepared therewith by providing anionic emulsifiers that have a decreased tendency to be present in the water phase due to the inclusion of a hydrophobic moiety.

The emulsifiers of the present invention may comprise a hydrophobic rosin acid moiety or a derivative thereof. Attached thereto, the emulsifier comprises a polar chain consisting of at least two repeating units comprising at least one carbon-oxygen bond. The oxygen atoms of the polar chain contribute to the hydrophilic functionality of the (overall) amphiphilic emulsifier. Attached to the other end of the polar chain, the emulsifier further comprises an anionic head group thus rendering the overall emulsifier anionic. The anionic head group also contributes to the hydrophilic character of the amphiphilic emulsifier.

Another aspect of the present invention relates to the adhesive characteristics of adhesive formulations prepared with the inventive tackifier dispersions. Adhesion is a surface phenomenon and therefore may be affected by the choice of emulsifier present in the adhesive. Generally, emulsifiers have a tendency to migrate to the interface between air and adhesive. Therefore, emulsifiers may change the surface properties and adhesion energy of the adhesive. This invention relates to the effect according to which adhesive properties of adhesives comprising a (water-based) tackifier dispersion (comprising anionic emulsifiers) can be significantly influenced by the type of emulsifier used. The presence of viscosity altering emulsifiers may also have an effect on the cohesive properties of the adhesive.

Some relevant technical terms as used in the context of the present invention are meant to be understood as follows (unless specifically indicated otherwise throughout the description).

“Adhesion” (or adhesive properties) in the meaning of the present invention relate(s) to the interaction of the adhesive formulation with the substrate to which it is applied. Characteristically, adhesive forces mainly concern the interface between adhesive and substrate. Suitable tests to measure adhesion are, for example, the “loop tack” test and the “peel strength” test. These tests are described in the FINAT Technical Handbook, 6^{th} edition, 2001.Loop tack is measured according to FINAT Test Method (FTM) 9 (page 22 et seq. of the Handbook). Peel Strength is measured according to FTM 1 (page 6 et seq. of the Handbook).

“Cohesion” (or cohesive properties) in the meaning of the present invention relates to interaction/forces within the adhesive. Typically, cohesive forces mainly concern the bulk phase of the adhesive. A suitable test to measure cohesion is the “shear cohesion” test. Shear Cohesion is measured according to FTM 8 (page 20 et seq. of the Handbook).

A “rosin acid” according to the present invention relates to an entity that has the following molecular backbone:

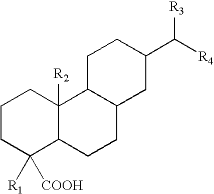

In one embodiment, R₁-R₄ each may be any alkyl group, such as, for example ethyl or methyl. In another embodiment, the structure comprises two conjugated double bonds. In a further embodiment, the rosin acid molecule comprises 20 carbon atoms. Structural isomers of this backbone are suitable as well.

At least one of the three rings may be aromatic. A “rosin acid” according to the present invention is understood to also comprise a mixture of various rosin acid molecules. Mixtures of this kind that are readily available and occur in nature include, but are not limited to, tall oil rosin, gum rosin or wood rosin. These natural mixtures may comprise rosin acids of the abietic type and/or the pimaric type such as abietic acid, palustric acid, neoabietic acid, levopirmaric acid, pimaric acid, isopimaric acid or dehydroabietic acid, among others, in varying amounts. Any such mixture is considered a rosin acid as long as at least one of the molecules of the mixture has the above described rosin acid backbone, or a structural isomer thereof.

In addition to rosin acids with one carboxylic acid functionality, rosin acids with two or more carboxylic acid functionalities are also considered as rosin acids in the meaning of the present invention.

A “rosin acid derivative” according to the present invention is any molecule that has the molecular rosin acid backbone as described above but is modified in at least one of the following ways. In one embodiment, at least one double bond is hydrogenated (hydrogenation). In another embodiment, at least one of the rings of the rosin and backbone is dehydrogenated so that an aromatic ring results (dehydrogenation). In a further embodiment, the carboxy-functionality of the rosin acid is modified, for example into an alcohol functionality (for example: methylated and hydrogenated gum rosin is converted to Abitol by means of hydrogenolysis). In another embodiment, the carboxy-functionality is modified into an amide functionality. In yet another embodiment, adducts to the conjugated double bonds of the rosin acid backbone are included, in particular the addition of maleic anhydride in a Diels-Alder type reaction. The resulting adduct is considered one type of a rosin acid derivative according to the present invention.

A “rosin ester” according to the present invention is any molecule in which at least two rosin acid or rosin acid derivative units are connected by means of at least one ester linkage. Any molecule with at least two hydroxyl groups can be used to provide the ester linkage between at least two rosin acids units. Common examples include, but are not limited to, glycerol esters, penta erythritol esters and (triethylene) glycol esters.

The “solid content” of a tackifier dispersion is given in % weight per overall weight of the dispersion (unless indicated otherwise). A test protocol illustrating how to measure the solid content is given in the “Examples” section.

“Water-based” tackifier dispersions according to the present invention are dispersions of tackifier entities wherein the solvent is generally water or an aqueous solution. However, mixtures of water with a non-aqueous solvent, in particular an organic solvent, would also be suitable as long as the foaming properties or other dispersion properties are not negatively affected. Mixtures of water with other water-soluble solvents could also be used as well.

Emulsifiers According to the Invention

In one embodiment of the present invention, the emulsifier molecule comprises at least the following functional entities (moieties):
at least one rosin acid moiety or at least one rosin acid derivative moiety,
a polar chain attached to said rosin acid or rosin acid derivative,
an anionic head group attached to the polar chain.

Mixtures of two or more types of emulsifier molecules of this structure are also an emulsifier according to the present invention.

The rosin acid (derivative) moiety is seen as imparting hydrophobic (lipophilic) character on the emulsifier molecule. The polar chain and the anionic head group are both seen as imparting hydrophilic (lipophobic) character on the emulsifier molecule.

In one embodiment of the present invention, the hydrophobic moiety is a rosin acid. When a rosin acid is used as the hydrophobic moiety, low viscosity values together with good foaming behavior and a particle size below 250 nm can be obtained. If a rosin acid is used as the hydrophobic moiety and the polar chain comprises oxygen, the resulting linkage between the hydrophobic moiety and the polar chain is typically an ester linkage.

In another embodiment, the rosin acid is obtained from a naturally occurring source such as tall oil rosin, gum rosin or wood rosin. Fractions or mixtures of these sources may be used as well. The mixtures may be a combination of two or more of the natural products with each other or the natural products may be mixed with purified or synthetically produced rosin acids as well. No limitations exist with respect to the degree of hydrogenation, dehydrogenation or variation of any of the “R” groups of the rosin acid as long as the carboxyl-functionality remains intact for at least some of the molecules.

In another embodiment, the carboxyl functionality of the rosin acid is converted into a hydroxyl functionality, for example by hydrogenolosis of a methylated rosin acid.

In another embodiment, the polar chain comprises a repetition of at least two units comprising at least one carbon atom linked to at least one oxygen atom, i. e. at least one carbon-oxygen bond per repeating unit. For example, a unit consisting of ethylene oxide (EO), i. e. —C₂H₄—O—, would be suitable thus resulting in polyethylene oxide chains. The polar chain does not need to be terminated by a group containing oxygen or to exclusively comprise C, O and H atoms. Amine terminated polar chains would be suitable as well. Block copolymers, for example comprising polypropylene blocks and polyethylene blocks (“pluronics”) are also seen as polar chains according to the present invention.

In a further embodiment, the polar chain comprises about 2 to 50 (repeating) units. For example, about 3 to 20 units or about 4 to 20 units may be used. Likewise, about 4 to 15 units, or about 4 to 11 units, or even about 5 to 9 units would be suitable according to the present invention.

The number of units forming the polar chain of the emulsifier may have an effect on the size of the tackifier particles in the dispersion generated with the emulsifier. A small particle size is generally favorable for the following reasons. First, the smaller the tackifier particles, the less likely the particles will settle gravitationally thus destabilizing the dispersion. Tackifier dispersions prepared with the inventive emulsifier with the proper length of the polar chain can be stable for years. Next, a small tackifier particle size may lead to an increased overall surface area thus binding more emulsifier molecules to the oil phase and reducing the emulsifier content in the water phase. This should lead to a reduced viscosity of the overall dispersion. Lastly, it has been found that tackifiers with large particle sizes may lead to increasingly poor foaming behavior. For polyethylene oxide chains, it has been found that the smallest particle size of tackifiers in the dispersion can be achieved when using emulsifiers with polar chains having EO units in the range from about 4 to about 15. For example, from about 4 to about 11 units or from about 5 to about 9 units would be suitable.

With respect to the anionic head group, any group that imparts a (partial) negative charge to the end group of the polar chain is suitable. For example, the end group of the polar chain could be functionalized with a mineral acid such as a (poly) phosphoric or a sulphuric acid. For phosphorylation, oxides or halogenides, such as phosphorous pentaoxide (P₂O₅), phosphorous trichloride (PCl₃) or phosphorous oxychloride (POCl₃) may be employed. For sulfation, the corresponding sulfuir oxides or halogenides may be used. In another embodiment, the polar chain may be modified to result in a carboxylic acid functionality (e. g. esterification). Any method would be acceptable according to the present invention provided that the head group renders an anionic emulsifier.

Using an anionic head group in the context of the present invention appears to provide repulsive electrostatic forces that prevent particle agglomeration/coagulation. Using an anionic head group also may allow for shorter polar chains in the present invention as compared to emulsifiers known in the prior art since not all of the hydrophilic character needs to come from the (long) polar chain.

The hydrophobic moiety according to the present invention, for example, the rosin acid (derivative) moiety, may lead to an emulsifier that has an increased affinity for hydrophobic tackifiers such as rosin esters, hydrocarbon resins, or mixtures thereof, as compared to emulsifiers comprising hydrophobic parts as known from the prior art such as, for example, alkyl phenols or alkyl alcohols.

Providing an emulsifier with a rosin acid (derivative) hydrophobic moiety may therefore be seen as improving the selectivity of the emulsifier for the oil-water interface in tackifier dispersions, thus resulting in a decrease of emulsifier molecules present in the water phase of the water-based tackifier dispersion. As a consequence, the viscosity of the water phase may be reduced. Therefore, the viscosity of the overall dispersion may also be reduced.

Tackifier Dispersion According to the Invention

The tackifier dispersion according to the present invention comprises water, at least one emulsifier as described above and at least one of the following tackifiers: at least one rosin ester or at least one hydrocarbon resin or at least one resin produced from vinyl aromatics monomers such as styrene, indene, alpha-methyl styrene, divinylbenzene, divinylbenzene with one or more alkyl groups, at least one terpene resin or any mixture of at least two of these tackifiers.

For example, at least one of the tackifiers can be a rosin ester. In this embodiment the structural similarity between the rosin ester and the rosin acid moiety used in the emulsifier may decrease the migration of the emulsifier to the surface. Migration potentially may be detrimental to the adhesive properties of adhesives comprising said emulsifier. Suitably, in embodiments where a hydrocarbon resin is used as a tackifier, alone or in a mixture with a rosin ester, C₅-C₉ hydrocarbon resins may be used.

In one embodiment of the present invention, the rosin ester may have an acid number (i. e. a number given in mg of KOH necessary to neutralize 1 g of the acid) of less than 25. In another embodiment, the hydrocarbon resin has a weight-averaged molecular weight ranging from about 200 to about 20,000 g mole⁻¹, for example, from about 4,000 to about 7,000 g mole⁻¹.

In another embodiment, at least one tackifier of the tackifier dispersion may have a softening point ranging from about −30° C. to about 160° C., such as for example, ranging from about 20° C. to about 120° C. [as measured according to the “ring-and-ball” method of ASTM E28-99 (2004) Standard Test Method for softening point of resins derived from naval stores by ring-and-ball apparatus].

The average particle size of the tackifiers in the tackifier dispersions as discussed above is suitably less than about 2 μm. For example, the average particle size of the tackifier is less than about 1 μm, or even less than about 500 nm. In another embodiment, the average particle size of the tackifiers is less than about 250 nm. Generally, particle sizes and particle size distributions are measured with (laser) light scattering methods.

In a further embodiment, the tackifier dispersions have a Brookfield viscosity of less than about 300 mPa·s or less than about 250 mPa s. Generally, viscosities are measured with a Brookfield LVT Viscometer. Emulsifiers with higher viscosities are covered by the present invention as long as the foam behavior is acceptable and the solid content is within the specified ranges.

The solid content of a tackifier dispersion according to the present invention suitably ranges from about 50% to about 70% by weight, such as for example from about 55% to about 65% by weight.

Adhesive Formulation According to the Invention

The inventive emulsifiers as applied to tackifier dispersions according to the present invention result in improved cohesion and adhesion properties of water-based adhesives prepared with said tackifier dispersions. For example, such adhesives can be advantageously used in the labeling and packaging industries, for water-based sticky tapes, road markings and flooring applications. In the aforementioned applications, the adhesive is pressure-sensitive. Other applications, in which the adhesive is not pressure sensitive, are included as well. Such applications include, but are not limited to barrier coatings or sealants.

In another embodiment of the present invention, the tackifier dispersion using the inventive emulsifier can be used to prepare an adhesive formulation. The adhesive formulation comprises at least one tackifier dispersion as described above and at least one polymer component. In general, the polymer component is an elastomeric component including elastomeric latexes, such as acrylics or styrene-butadiene rubber. Other polymers suitable for use with the tackifier dispersions according to the present invention include but are not limited to:
suspensions of natural rubber,
acrylic polymers derived from 2-ethylhexyl acrylate, butyl acrylate, methyl methacrylate, methacylic acid, and acrylic acid or mixtures thereof,
polystyrene,
styrene-butadiene copolymers,
polymers derived from vinyl acetate, such as ethylene vinyl acetate,
poly chloroprene, or
acrylonitrile-butadiene copolymers.

Any mixture of two or more of these polymers could suitably be used as well.

In order to prepare the inventive wet adhesive formulation (i. e. water-based), a tackifier dispersion according to the present invention and latex may be blended. Generally, the adhesive formulation consists of about 15% to about 50% of tackifier, such as for example about 20% to about 40% (based on dry weight).

Exemplary Methods of Preparing the Emulsifier According to the Present Invention:

Schematic synthesis routes for preparing nonionic intermediates and anionic emulsifiers according to the present invention based on polyethylene oxide chains as the polar chain are described by way of example in the following:

(I) Possible Synthesis Route: Esterification Route:
(a) esterifying rosin acid with excess polyethylene glycol (PEG);
(b) separation of intermediate product (A) from step (a) from unreacted PEG; 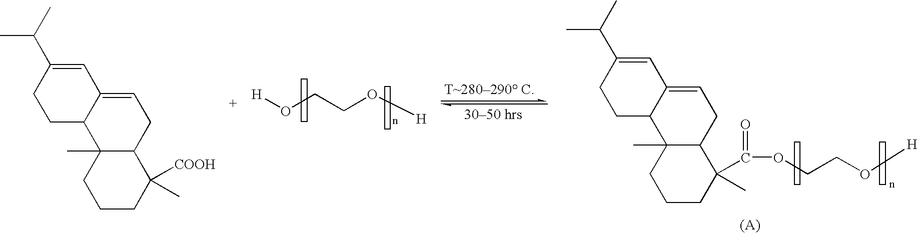
(c) reaction of product from step (b) with a mineral or carboxylic acid to arrive at anionic emulsifier; here, (poly) phosphoric acid is used.

The primary molecular structure of the anionic emulsifier comprising a hydrophobic rosin acid based part is shown schematically in the following:

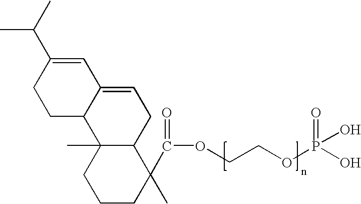

The product mixture may also contain low amounts of di-phosphate ester and free phosphoric acid (20-60 mole %), among others. Purification steps as necessary may be performed according to standard methods known from the prior art.

(II) Alternate Synthesis Route: Ethoxylation Route:
(a) a rosin acid derivative is prepared by conversion of the carboxyl-group to a hydroxyl group
(b) ethoxylation of hydroxyl functionality with ethylene oxide (EO), to arrive at a polyethylene oxide chain; 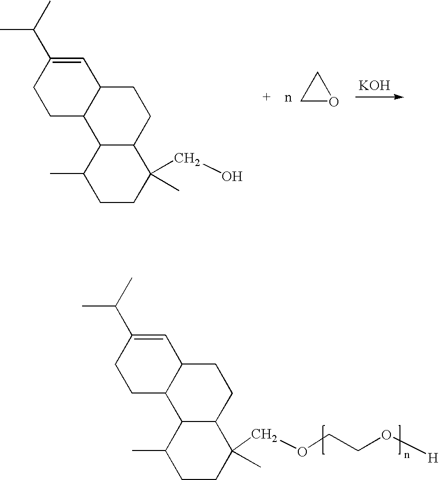
(c) raw product is vacuum stripped to remove unreacted EO;
(d) reaction of intermediate product (B) from (c) with a mineral or carboxylic acid, here: polyphosphoric acid.

While the ethoxylation of a rosin acid derivative is described here, a rosin acid may be used as well. The primary molecular structure of the anionic emulsifier comprising a hydrophobic hydroxyl modified rosin acid moiety is shown schematically in the following:

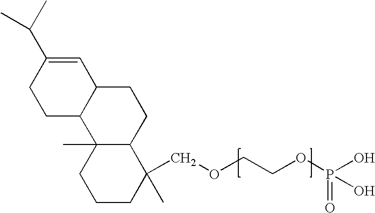

This product mixture may also contain low amounts of di-phosphate ester and free phosphoric acid (20-60 mole %), among others. Purification steps as necessary may be performed according to standard methods known from the prior art.

The typical product according to both routes is a semi-solid, becomes liquid at elevated temperatures and has a moderate solubility in water. Typically, in its salt-form, the product has good water solubility.

In one method of preparing the nonionic intermediate (A) according to the esterification route, rosin acid (mixtures) is/are reacted with a molar excess of polyethylene glycol in the presence of at least one metal oxide catalyst. Typically, the reaction temperature is from about 270° C. to about 290° C. The reaction is preferably conducted under inert nitrogen conditions. Generally, polyethylene glycol as used in this method has a number-averaged molecular weight ranging from about 100 to about 1,000 g mole⁻¹, such as for example from about 200 to about 500 g mole⁻¹.

Typical reaction times are about 30 hours, reaching a conversion rate between about 90 and about 99%. In one embodiment, unreacted polyethylene glycol is removed from the intermediate reaction product by repeated water-diethyl ether extractions. In another embodiment, less than about 2% by weight of NaCl is added to the water in order to obtain a good phase separation in the extraction steps. Typically, about five extraction steps are needed to reach a polyethylene glycol level of less than about 2% by weight in the intermediate nonionic product. If the PEG chain is made longer than about 7 EO units, unwanted solubility of the nonionic intermediate is found; on the other hand, if the PEG chain is made shorter than about 5 EO units, significant unwanted solubility of PEG in ether is found.

In another embodiment, the molar ratio of rosin acid to polyethylene glycol ranges from about 1:2 to about 1:10, such as for example, from about 1:3 to about 1:7. By further example, a ratio of 1:5 is also suitable.

An alternative method of preparing the nonionic intermediate comprises the reaction of a rosin acid or of a rosin acid derivative having at least one hydroxyl functionality with ethylene oxide, or a molecule with similar functionality (ethoxylation). This reaction is typically conducted in the presence of a catalytic amount of KOH. In addition, the reaction is carried out at temperatures between about 160° C. to about 190° C., preferably under inert nitrogen conditions. Further, a pressure from about 4 to about 5 bar is generally applied. One advantage of this method over the esterification route described above is that the extraction steps are not necessary, thus not limiting the number of EO units.

The anionic emulsifier according to the present invention may be prepared by reaction of the nonionic intermediate (A) or (B), or of a mixture thereof, as described above, with a mineral acid, a carboxylic acid or any mixture thereof.

In another embodiment, (poly) phosphoric acid may be used. Equivalents of polyphosphoric acid are typically expressed in % phosphoric acid. This can be converted into an equivalent mass of P₄O₁₀. This equivalent mass can react with an equivalent mass of hydroxyl. In this case the molecular ratio of hydroxyl to P₄O₁₀ suitably ranges from about 5:1 to about 1:5 such as for example about 3:1(which corresponds to an excess of hydroxyl).

If phosphorylation is employed, the phosphorylation step preferably comprises the slow addition of polyphosphoric acid to the nonionic intermediate (A) or (B), or a mixture thereof, at a temperature ranging from about 60° C. to about 70° C.

Polyphosphoric acid is added at timed intervals ranging from about 1 to about 90 minutes, such as for example from about 10 to about 70 minutes. In one embodiment, the reaction temperature may be increased to about 100° C. for 3 to 4 hours after the addition of polyphosphoric acid.

According to the present invention, with respect to manufacturing of the emulsifier, ethoxylation may be used instead esterification due to the money-saving omission of extraction steps. It is also suitable to ethoxylate a rosin acid rather than a rosin acid derivative to provide ester linkages rather than ether linkages. Overall, the suitable methods of manufacturing the emulsifier according to the present invention may comprise at least one of the following steps: (a) ethoxylation of at least one rosin acid with ethylene oxide; (b) reaction of the intermediate product from (a) with a mineral or a carboxylic acid.

Exemplary Method of Preparing Tackifier Dispersions Using the Emulsifier according to the present invention.

In one embodiment to arrive at tackifier dispersions based on the emulsifiers according to the present invention, said tackifier dispersions may be prepared according to a batch inversion process.

In another embodiment, the tackifier, or a tackifier mixture, may be heated approximately 10 to 30° C. above the softening point of the tackifier/the mixture of tackifiers. The emulsifier according to the present invention then may be added to said tackifier/tackifier mixture. In a further embodiment, the emulsifier may be added together with a neutralizing agent. Suitable neutralizing agents include NaOH, KOH or triethanol amine.

In a further step, water may be slowly added to the tackifier mixture under agitation until phase inversion is reached. In one embodiment, the resulting emulsion is further diluted to the desired total solid content. The resulting dispersion is then slowly cooled under gentle agitation.

The amount of emulsifier added to the tackifier is suitably between about 4 to 5 about 9 parts, such as, for example, from about 5 to about 8 parts, per 100 parts tackifier, respectively (in parts per weight). The amount of neutralizing agent added is adjusted in a manner so that the final dispersions have pH values ranging from about 4 to about 10 or from about 6 to about 8.

This invention can be further illustrated by the following examples of potential embodiments thereof, although it will be understood that these examples are included merely for the purposes of illustration and are not intended to limit the scope of the invention unless otherwise specifically indicated.

### EXAMPLES

### Example 1

### Preparation of Intermediate Product A (Esterification)

An electrically heated 2 liter glass reactor, equipped with agitator, thermocouple, nitrogen inlet and Dean-Stark trap with cooler, was charged with Gum Rosin (Eastman Chemical Company, Middelburg, NL) and polyethylene glycol (PEG300; Aldrich Chemical Company Milwaukee, Wis.) with a number average molecular weight of 300 in a molar equivalent ratio of COOH:OH =1:10. The mixture was heated under inert nitrogen conditions to 180° C. and 0.01% ZnO (based on the weight of Gum Rosin) was added as esterification catalyst. The mixture was further heated to 290° C. and water was continuously distilled off.

The reaction mixture was allowed to react until a conversion of at least 90% was reached. Typical reaction times were between 25 and 30 hours. The raw intermediate was cooled to ambient and dissolved in diethyl ether. 100 parts raw product was dissolved in 80 parts diethyl ether. 67 parts of an aqueous NaCl-solution (2% by weight) were added to the solution. The mixture was vigorously shaken in a separation funnel and left to stand until two or three separate layers were obtained. The aqueous layer, containing residual PEG300 and NaCl, was removed. This procedure was repeated four times with the original diethyl ether solution, until at least 98% of the residual PEG300 was removed from the adduct. Diethyl ether was removed, using a rotation film evaporator, at a temperature of 70 to 80° C. under reduced pressure (100 to 200 mbar) until no diethyl ether vapors could be determined.

### Example 2

### Preparation of Intermediate Product B (Esterification)

The procedure of Example 1 was repeated by replacing PEG 300 by polyethylene glycol (PEG200; Aldrich Chemical Company Milwaukee, Wis.) with a number average molecular weight of 200.

### Example 3

### Preparation of Intermediate Product C (Ethoxylation)

A 1 liter autoclave, equipped with agitator, thermocouple, nitrogen inlet and pressure gauge was heated to approximately 85° C. and charged with 300 g Abitol E (Eastman Chemical Company, Middelburg, NL) and 0.3 g KOH-powder. Agitation was started at 500 rpm. The reactor was inerted three times with nitrogen. The mixture was heated to 180° C. Ethylene oxide (generally 5, 7, 9 or 11 moles) was continuously added to the reactor in about 16 hours, using a dosing vessel pressurized to 5 bars. The pressure in the reactor was 4.7 bars. The mixture was allowed to react overnight. The reactor was inerted three times with nitrogen and cooled to ambient temperature and discharged. The preferred molar ratio Abitol E:EO is 1:7.

### Example 4

### Preparation of Anionic Emulsifiers

An electrically heated 250 ml three-neck glass reactor, equipped with agitator, thermocouple, nitrogen inlet, dropping funnel and cooler, was charged, in separate batches, with the intermediate products from Examples 1, 2 and 3 and heated to 120 to 140° C. Traces of water were removed under reduced pressure (200 to 400 mbar) and nitrogen purge until the adduct had a water content less than 500 ppm. The adduct was cooled to 80° C. and polyphosphoric acid (115% H₃PO₄; Aldrich Chemical Company Milwaukee, Wis.) was slowly added in the equivalence ratio OH:P₄O₁₀=3:1. An exotherm of about 10° C. was observed. After addition of the polyphosphoric acid, the reaction temperature was increased to 100° C. and left to react for 3 to 4 hours. The progress of the reaction was monitored by determining the titration curve.

### Example 5

### Preparation of Tackifier Dispersions—200 g scale

A stainless steel beaker was charged with 100 parts of Precursor 105 resin (Eastman Chemical Company, Middelburg, NL) and heated to approximately 100° C. 6 to 8 parts of surfactants (obtained from example 4) and 20% sodium hydroxide were added to the molten resin. The weight ratio of surfactant and sodium hydroxide were chosen in such way that the pH of the final dispersion was between 6 and 9. The mixture was reheated to a temperature between 90 and 100° C. The agitation speed was increased to 1800 rpm and hot water was slowly added to the viscous mixture until the systems inverted to a water-in-oil dispersion. The dispersion was further diluted to the desired solid content. The dispersion was then cooled to ambient. The resulting dispersions have a pH between 6 and 9 and a mean particle sizes between 200 and 300 nm.

Properties of different dispersions are summarized in table 1. Dispersions A and B have been prepared from Example 1 (nonionic intermediate), Example 4 (anionic surfactant) and Example 5 (dispersion). Dispersion C is like dispersion A and B except that the dispersion has been obtained according to Example 6 described below. Dispersion D is Example 3-Example 4-Example 5. Dispersion E is Example 3-Example 4-Example 6 and Dispersion F is Example 2-Example 4-Example 5.

### Example 6

### Preparation of Tackifier Dispersions—3.5 kg scale

In a 4 liter electrically heated, stainless steel reactor, equipped with a ribbon type of agitator and a scraper, moving in opposite directions, 100 parts of Precursor 105 resin (Eastman Chemical Company, Middelburg, NL) was heated to approximately 100° C. 7 parts of surfactant (obtained from Example 4) and 20% sodium hydroxide were added to the molten resin. The weight ratio of surfactant and sodium hydroxide were chosen in such way that the pH of the final dispersion was between 6 and 7. The mixture was homogenized for one minute with an agitation speed of 150 rpm. The agitation speed was increased to 250 rpm. Hot water was slowly added at a rate of 50 g/min. The temperature dropped to approximately 90° C. until the system inverts to a water-in-oil dispersion. Generally, inversion takes place when between 10 and 20% water is added (based on the weight of resin). The dispersion was further diluted to the desired solid content at a rate of 100 g/min. The dispersion was then cooled to ambient and discharged from the reactor. The resulting dispersions have a pH between 6 and 7 and a mean particle sizes between 200 and 300 nm.

Properties of different dispersions are summarized in table 1 (see Example 5).

### Example 7

### Preparation of Pressure Sensitive Adhesives

Acrylic latex (Acronal V215, obtained from BASF AG, Ludwigshafen, D) and the tackifier dispersions from example 5 and 6 were blended and left to stand overnight. The resulting wet adhesive formulation had a resination level of 25% (based on dry weight). The wet adhesive formulation was coated on silicon release paper (90 gsm) and dried in a preheated oven for 60 seconds at a temperature of 110° C. The adhesive coating was then transferred on a paper backing (78 gsm; Crown van Gelder) and stored for one night (at 23° C. and 50% RH). Adhesive properties, like loop tack, peel strength and shear cohesion were measured. The measurements were performed according to FINAT Standard Methods.

Adhesive properties are summarized in table I

TABLE I

| | | | | | | | | | | Shear |
|---|---|---|---|---|---|---|---|---|---|---|
| | | | | Solid | Brookfield | | Loop | Peel | Peel | Cohesion |
| | | | Particle | Content | LVT Viscosity | Foam | Tack to | strength | strength | to steel |
| dispersion⁰⁾ | Linkage¹⁾ | pH | Size (nm)²⁾ | (wt %)³⁾ | (cP)⁴⁾ | behavior⁵⁾ | PE (N)⁶⁾ | to PE(N)⁷⁾ | to CB (N)⁷⁾ | (hrs)⁸⁾ |
| A | Ester | 7.0 | 240 | 58.9 | 125 | +++ | 13 | 17 | 15 | 21 |
| B | Ester | 6.3 | 230 | 60.7 | 280 | ++ | 12 | 16 | 16 | 10 |
| C | Ester | 6.9 | 205 | 59.2 | 370 | +++ | 12 | 17 | 13 | 9 |
| D | Ether | 6.4 | 280 | 60.9 | 390 | ++ | 11 | 15 | 12 | 10 |
| E | Ether | 6.4 | 240 | 58.8 | 240 | ++⁹⁾ | 10 | 16 | 12 | 9 |
| F | Ester | 8.8 | 250 | 54.2 | 180 | ++ | 10 | 15 | 6 | 27 |
| Prior art¹⁰⁾ | — | 6.8 | 190 | 50.2 | 700 | ++ | 11 | 16 | 11 | 5 |
| prior art | — | 6.8 | 200 | 54.8 | 250 | + | 11 | 11 | — | 10 |

⁰⁾See Example 5 for details of the manufacture of the respective dispersions
¹⁾Chemical linkage between hydrophobic and hydrophilic moiety.
²⁾Determined by laser scattering (Horiba LA-900)
³⁾Determined by method as described in “Example Section” (Labwave 9000)
⁴⁾Brookfield LVT Viscosity: All measurements were performed at 60 rpm and spindle 2.
⁵⁾+ = moderate foam behavior (free of air within 24 hours)
++ = good foam behavior (free of air within 16 hours)
+++ = excellent foam behavior (free of air within 8 hours)
⁶⁾FINAT Test Method 9; PE = polyethylene substrate
⁷⁾FINAT Test Method 1; CB = card board
⁸⁾FINAT Test Method 8
⁹⁾Dispersion shows excellent foam behavior when diluted to a solid content of 55%
¹⁰⁾prior art emulsifiers to prepare dispersion are phosphate esters of nonyl phenol ethoxylates

Test Method for Measuring the Solid Content of Tackifier in a Tackifier Dispersion

The method for measuring the total solids content of resin dispersions as used in the context of the present description makes use of a Lab Wave 9000 Microwave.

According to the test method, the sample is analyzed by using the method of Constant Weight. The sample is dried until a constant weight is achieved. Dryness is specified by defining a maximum acceptable weight loss over a specified time interval. During the specified time interval, when the loss is equal to or less than the loss as specified, the analysis stops and results are calculated. The Constant Weight procedure permits analysis of a sample without prior knowledge of the required drying time.

Parameters Constant Weight

| Microwave Power: | 75% (487.5 Watt; 100% equals 650 Watt | |
|---|---|---|
| | max. output) | |
| Time interval: | 10 | seconds |
| Weight loss differential: | 0.1 | mg |
| Maximum run time: | 10 | minutes |
| Balance set points | | |
| Minimum weight: | 1 | gram |
| Maximum weight: | 2 | gram |

In drawings and specification there have been disclosed typical preferred embodiments of the invention and, although specific terms are employed, they are used in a generic and descriptive sense only and not for purposes of limitation, the scope of the invention being set forth in the following claims.

The invention has been described in detail with particular reference to preferred embodiments thereof, but it will be understood that variations and modifications can be effected within the spirit and scope of the invention.

What is claimed is:

1. An emulsifier for use in a tackifier dispersion comprising:
(i) at least one rosin acid moiety or at least one rosin acid derivative moiety,
(ii) a polar chain attached to the rosin acid or rosin acid derivative, and
(iii) an anionic head group attached to the polar chain, wherein the polar chain comprises at least two repeating units comprising at least one carbon-oxygen bond in at least one repeating unit.

2. The emulsifier according to claim 1, wherein the number of repeating units in the polar chain ranges from about 3 to about 20.

3. The emulsifier according to claim 1, wherein the number of repeating units in the polar chain ranges from about 5 to about 9.

4. The emulsifier according to claim 1, wherein the repeating unit is an ethylene oxide unit.

5. The emulsifier according to claim 1, wherein the polar chain is attached to the rosin acid or rosin acid derivative moiety via an ester linkage.

6. The emulsifier according to claim 1, wherein the rosin acid or rosin acid derivative is obtained from a tall oil rosin, gum rosin or wood rosin or from mixtures or fractions thereof.

7. The emulsifier according to claim 1, wherein the anionic head group is introduced into the emulsifier by at least one of the following methods: phosphorylation, sulfation or carboxylation.

8. A tackifier dispersion for use in an adhesive formulation comprising:
(i) water,
(ii) at least one emulsifier according to any one of claims 1-7 and
(iii) at least one of the following tackifiers: (a) at least one rosin ester or (b) at least one hydrocarbon resin or (c) at least one resin produced from vinyl aromatics monomers such as styrene, indene, alpha-methyl styrene, divinylbenzene, divinylbenzene with one or more alkyl groups or (d) at least one terpene resin or (e) a mixture of at least two of these tackifiers or one of these tackifiers with at least one other tackifier.

9. The tackifier dispersion according to claim 8, wherein the tackifier comprises a rosin ester with an acid number of less than about 25.

10. The tackifier dispersion according to claim 8, wherein the tackifier comprises a hydrocarbon resin with a chain length ranging from C₅ to C₉.

11. The tackifier dispersion according to claim 8, wherein the average particle size of the tackifiers in the tackifier dispersion is less than about 2 μm.

12. The tackifier dispersion according to claim 8, wherein the average particle size of the tackifiers in the tackifier dispersion is less than about 1 μm.

13. The tackifier dispersion according to claim 8, wherein the average particle size of the tackifiers in the tackifier dispersion is less than about 500 nm.

14. The tackifier dispersion according to claim 8, wherein the average particle size of the tackifiers in the tackifier dispersion is less than about 250 nm.

15. The tackifier dispersion according to claim 8, wherein the solid content of the tackifier dispersion ranges from about 55% to about 65% by weight.

16. An adhesive formulation comprising at least one tackifier dispersion according claim 8 and at least one polymer component.

17. The adhesive formulation according to claim 16, wherein the polymer component is an elastomeric latex.

18. The adhesive formulation according to claim 17, wherein the elastomeric latex is selected from the group consisting of acrylic polymers, styrene-butadiene copolymers, suspensions of natural rubber, or polymers derived from vinyl acetate, poly chloroprenes or acrylonitrile-butadiene copolymers.

19. The adhesive formulation according to claim 16, wherein the adhesive formulation consists of about 20% to about 40% of tackifier based on dry weight.

20. A method for manufacturing the emulsifier of claim 1 comprising:
(a) ethoxylating at least one rosin acid with ethylene oxide;
(b) reacting the intermediate product of (a) with at least one mineral acid and/or at least one carboxylic acid.

21. An adhesive for attaching labels onto any kind of surface; for packaging applications, for flooring applications, for road marking; or for any type of water-based tapes, barrier coatings or sealants comprising the adhesive formulation of claim 16.
